(19) United States
(12) Patent Application Publication
(10) Pub. No.: US 2012/0189972 A1
(43) Pub. Date: Jul. 26, 2012

(54) Aesthetically Enhanced Temporary Anchorage Device and Method of Use Thereof

(75) Inventor: Fred Robinson Smith, Pittsburgh, PA (US)

(73) Assignee: INGENIOUS CONCEPTS, INC., Allison Park, PA (US)

(21) Appl. No.: 13/324,478

(22) Filed: Dec. 13, 2011

Related U.S. Application Data
(60) Provisional application No. 61/435,977, filed on Jan. 25, 2011.

(51) Int. Cl. A61C 7/00

(52) U.S. Cl. 433/18; 433/24

(57) ABSTRACT

A temporary anchorage device is disclosed having a head located at an exposed end of the device, a square neck attached to the head, a tapered shaft having threads at an implanted end which is opposite the head, and a transmucosal collar positioned between the tapered shaft and the square neck. A visible colored section is attached to the device between the exposed end and the transmucosal collar. In a second embodiment, a cap having a decorative feature is placed over the head of the implant. The visible colored section and decorative feature may be detachable from the implanted device and exchangeable. The present invention also includes a method for aesthetically enhancing a temporary anchorage device.

### CROSS REFERENCE TO RELATED APPLICATIONS

This application claims the benefit under 35 U.S.C. §119(e) to U.S. Provisional Patent Application No. 61/435,977, filed Jan. 25, 2011, which is hereby incorporated by reference in its entirety.

### BACKGROUND OF THE INVENTION

1. Field of the Invention

The present invention relates to temporary anchorage devices for dental and orthodontic procedures and, in particular, to screw implants for orthodontic treatment which are aesthetically enhanced by including a decorative feature.

2. Description of Related Art

In the field of dentistry and orthodontics, temporary anchorage devices (TADs) are used to effectively move teeth during orthodontic treatment. TADs reduce overall treatment time, patient compliance, and the need for surgery. One type of TAD is the mini-screw implant. The typical mini-screw implant is a titanium screw that has a head at one end and a tapered shaft at an opposite end. The mini-screw is often implanted into bone between teeth. It can also be implanted in other areas of the mouth as well, including, but not limited to, the mid-palatal suture. An example of a mini-screw implant of this type is described in U.S. Pat. No. 6,669,473 to Maino and in U.S. Patent Application Publication No. 2011/0165532 to Benvegnu' et al.

If a screw having a different head configuration is later required, the mini-screw currently implanted in the patient's mouth must be removed and replaced with the new mini-screw. While in the mouth, the head of the screw is clearly visible. Although the patient certainly desires and enjoys the results of utilizing the mini-screw implant, many patients dislike the metallic appearance of the mini-screw implant. A need therefore exists for a mini-screw implant having an enhanced aesthetic quality.

### SUMMARY OF THE INVENTION

A temporary anchorage device according to the present invention includes a head located at an exposed end of the anchorage device, a square neck adjacent and attached to the head, a tapered shaft having threads located at an implanted end of the device which is opposite the head, and a transmucosal collar positioned between the first threaded shaft and the square neck. The improvement of the present invention comprises a visible colored section located on the exposed end of the device, above the transmucosal collar, which is visible after the device has been implanted. In one non-limiting embodiment of the invention, the visible colored section is detachable from the anchorage device and exchangeable with a visible colored section of a different color.

In another embodiment of the invention, a temporary anchorage screw for orthodontic treatment includes a head located at one end of the screw, a square neck attached to the head, a tapered shaft having threads at an end opposite the head, and a transmucosal collar positioned between the tapered shaft and the square neck. The head of the implant may be permanently attached or detachably coupled to the square neck. According to this embodiment, the invention further comprises a cap having a retention groove placed over the head of the implant. The cap has a decorative feature, such as a visible colored section. The decorative feature is detachable from the device after the device has been implanted and exchangeable for a different decorative feature. In use, the decorative cap is visible to others when the user opens his or her mouth.

The present invention also includes a method of aesthetically enhancing a temporary anchoring device. The method includes providing a temporary anchoring device comprising a head located at an exposed end of the device, a square neck adjacent and attached to the head, a tapered shaft having threads located at an implanted end which is opposite the head, and a transmucosal collar positioned between the first threaded shaft and the square neck. The method further comprises attaching a visible colored section to the device between the exposed end and the transmucosal collar and securing the device, including the attached visible colored section, in the mouth of a patient. Optionally, the method further comprises, after the device is secured in the mouth of the patient, removing the visible colored section and replacing the visible colored section with a section having a different color.

### BRIEF DESCRIPTION OF THE DRAWINGS

FIG. 1 is a perspective view of an embodiment of a temporary anchorage device according to the present invention;

FIG. 2 is a perspective view of an embodiment of a temporary anchorage screw with a cap separated from the mini-screw according to the present invention;

FIG. 3 is a perspective view of the embodiment of a temporary anchorage screw with a cap placed over the head of the screw according to the present invention;

FIG. 4 is a perspective view of the second embodiment of a temporary anchorage screw having a separate but attachable head and body according to the present invention;

FIG. 5 is a top view of the body of the second embodiment of the temporary anchorage screw according to the present invention;

FIG. 6 is a perspective view of the third embodiment of a temporary anchorage screw detachable head having a rounded dome shape; and

FIG. 7 is a perspective view of the fourth embodiment of a temporary anchorage screw head having slotted grooves in the shape of an “X”.

### DESCRIPTION OF THE PREFERRED EMBODIMENTS

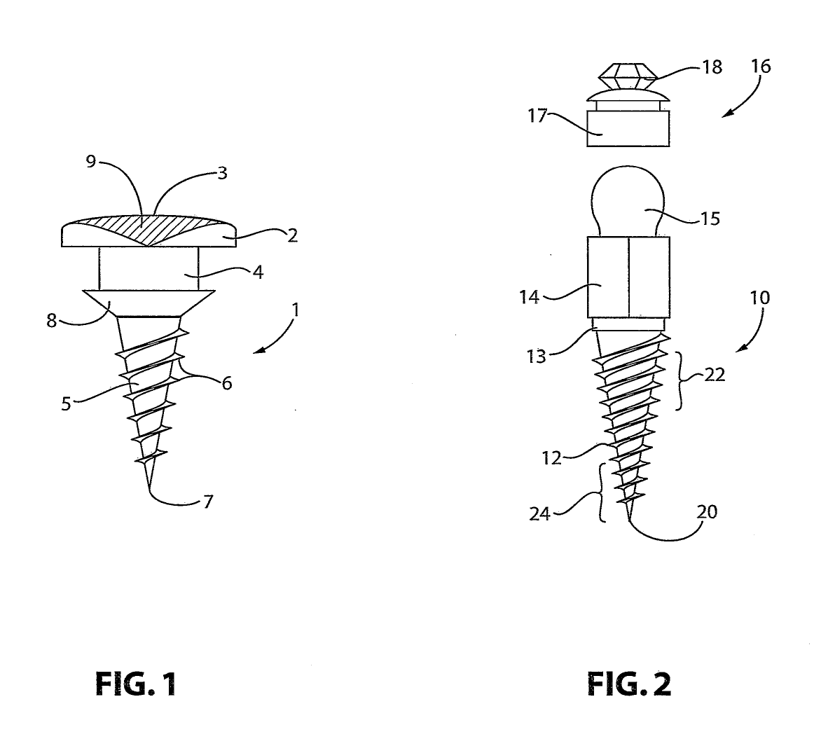

A non-limiting embodiment of a temporary anchorage device according to the present invention is show in FIG. 1. A temporary anchorage device 1 for orthodontic treatment comprises a head 2 located at an exposed end 3 of the device 1, a square neck 4 adjacent and attached to the head 2, a tapered shaft 5 having threads 6 located at an implanted end 7 which is opposite the head 2, and a transmucosal collar 8 positioned between the tapered shaft 5 and the square neck 4. The device further comprises a visible colored section 9 located at the exposed end 3 of the device 1 between the transmucosal collar 8 and the exposed end 3 which can be seen after the device 1 is implanted.

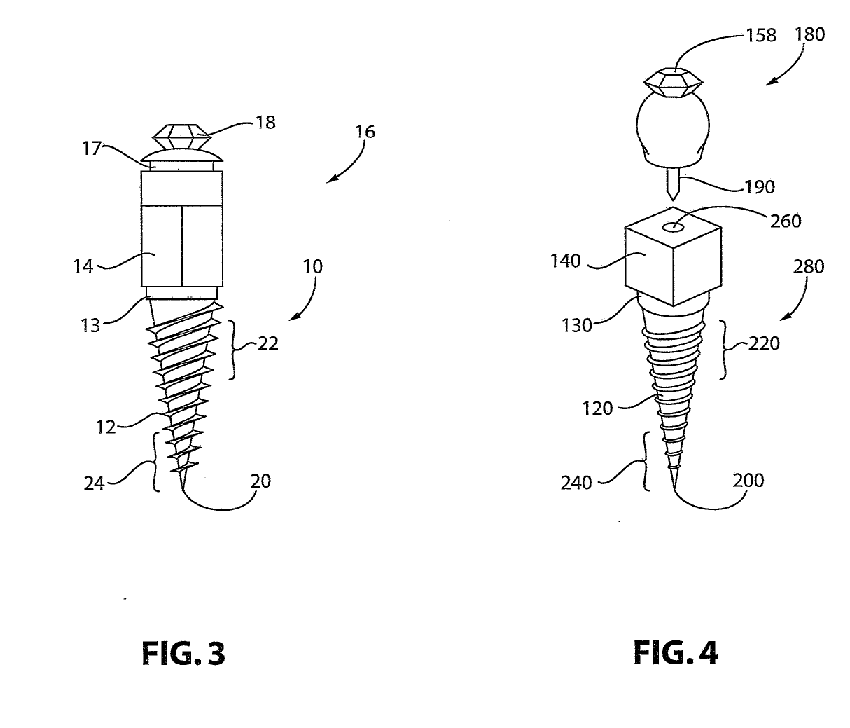

A temporary anchorage screw according to one embodiment of the present invention is shown in FIGS. 2-3. A tapered shaft 12 having threads is located at one end of the mini-screw 10. At a narrow end 24 of the tapered shaft 12 is an implantable tip 20. A broader end 22 of the tapered shaft 12 is attached to a transmucosal collar 13. A square neck 14 is attached to the transmucosal collar 13. A head 15 is located at an end opposite the tapered shaft 12 and connected to the square neck 14.

A cap 16 can be placed over the head 15. The cap 16 has a retention groove 17 where orthodontic appliances can be attached thereto. The cap 16 has a decorative feature 18. The decorative feature 18 includes, but is not limited to, a jewel, a jewel-like material, a visibly colored material, or a colored emblem. In use, the tapered shaft 12 is inserted into the mouth of a patient. However, the head 15 of the mini-screw 10 is exposed. When the cap 16 is placed over the head 15 of the mini-screw 10 as shown in FIG. 2, the decorative feature 18 is visible to others when the user opens his or her mouth.

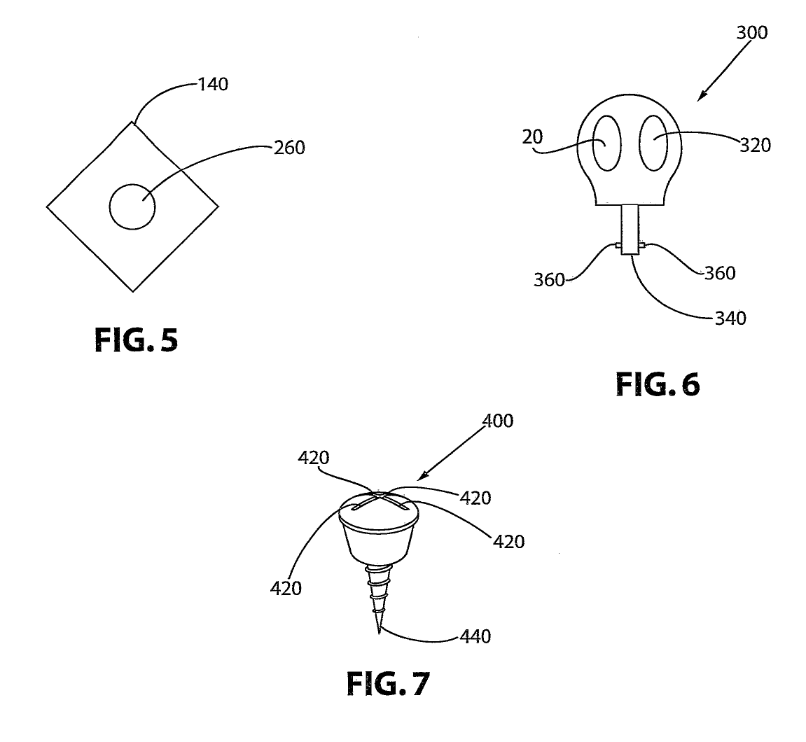

A second embodiment of the temporary anchorage screw according to the present invention is shown in FIGS. 4-5. In this embodiment, the present invention is composed of a separate head 180 and body 280 that can be temporarily attached. A tapered shaft 120 having threads is located at one end of the body 280. At a narrow end 240 of the tapered shaft 120 is an implantable tip 200. A broader end 220 of the tapered shaft 120 is attached to a transmucosal collar 130. A square neck 140 is located at an end opposite the tapered shaft 120 and connected to the transmucosal collar 130.

The square neck 140 contains an internal cavity 260 that is capable of receiving a connecting member. FIG. 5 is an enlarged top view of the square neck 140 and internal cavity 260. The internal cavity 260 can have a range of depths with different structural features in order to receive various types of connecting members.

The head 180 includes a decorative feature 158 extending outwards and a connecting member 190 extending in the opposite direction. The connecting member 190 can be inserted into the internal cavity 260 of the square neck 140. The connecting member 190 can have different shapes and sizes including, but not limited to, a threaded shaft and an elongated rectangular shank having one or more projections, such as bumps or raised portions. The connecting member 190 would be sized and shaped so as to interact with and engage the internal cavity 260 of the square neck 140. In operation, the connecting member 190 slides down into the internal cavity 260 until the connecting member 190 is properly engaged and “locks” into place. This function ensures proper alignment of the connecting member 190 with respect to the internal cavity 260.

Once the connecting member 190 is inserted into the internal cavity 260 of the square neck 140 and the head 180 is properly secured into the body 280, an orthodontic appliance can be connected to the head 180. Because the head 180 is detachable and can be replaced without removing the body 280 of the mini-screw from the patient's mouth, a clinician can easily replace the head 180 with one having a different configuration. This also allows the patient to choose a head having a different decorative feature 158.

A third embodiment of the screw according to the present invention is shown in FIG. 6. In this embodiment, a detachable head 300 has a rounded dome shape with a plurality of holes 320 throughout. The plurality of holes 320 allows wire or other material to be run through the head. A connecting member 340 extends outwards. The connecting member 340 in FIG. 6 is an elongated rectangular shank having projections 360 on each side, which is one of many designs that can used. A driving tool designed to engage the shape of the head 300 in FIG. 6 would be used to attach and detach the head 300 without disturbing the position of the mini-screw implanted in the patient's mouth.

In a fourth embodiment of the screw shown in FIG. 7, a detachable head 400 has slotted grooves 420 in the shape of an “X”. A connecting member 440 extends outwards. The connecting member 440 in FIG. 7 is a tapered shaft having threads, which is one of many designs that can be utilized. A screwdriver designed to engage the slotted grooves 420 could be used as the driving force. In operation, the driver would remove and replace the head 400 in FIG. 7 without disrupting the body 280 of the mini-screw implanted in the patient's mouth. There are a variety of other head sizes and shapes that can be utilized such as a hexagonal-shaped socket head. The design of each head would correspond to the driving mechanism used to attach and detach it to the square neck of the mini-screw.

Overall, the present invention decreases the self-consciousness that typically goes along with the use of temporary anchorage mini-screw implants, especially in children. In addition, the present invention allows the user to express him or herself via the visible colored section 9 or decorative feature 18 of the cap 16 or the decorative feature 158 of the head 180. Further, the user can change the color or appearance of the visible colored section 9, or decorative feature of the cap 16, or head 180 as often as he or she would like.

This invention has been described with reference to the preferred embodiments. Obvious modifications and alterations will occur to others upon reading and understanding the preceding detailed description. It is intended that the invention be construed as including all such modifications and alterations.

The invention claimed is:

1. A temporary anchorage device for orthodontic treatment having a head located at an exposed end of the device, a square neck adjacent and attached to the head, a tapered shaft having threads located at an implanted end of the device which is opposite the head, and a transmucosal collar positioned between the threaded shaft and the square neck, the improvement comprising:
a visible colored section located on the exposed end of the device above the transmucosal collar which can be seen after the device is implanted.

2. The device of claim 1, in which the visible colored section is detachable from the device after the device has been implanted and can be exchanged with a visible colored section of a different color.

3. The device of claim 1, in which the visible colored section comprises a cap having a retention groove that is placed over the head.

4. A temporary anchorage screw implant comprising:
a head located at one end of the screw;
a square neck adjacent and attached to the head;
a tapered shaft having threads located at an end opposite the head;
a transmucosal collar positioned between the first threaded shaft and the square neck; and
a cap having a retention groove that is placed over the head, the cap comprising a decorative feature.

5. The screw of claim 2, in which the decorative feature is detachable from the device after the device has been implanted and can be exchanged with a different decorative feature.

6. The screw of claim 2, wherein the decorative feature comprises a visible colored section.

7. A method of aesthetically enhancing a temporary anchoring device comprising:
providing a temporary anchoring device comprising a head located at an exposed end of the device, a square neck adjacent and attached to the head, a tapered shaft having threads located at an implanted end of the device which is opposite the head, and a transmucosal collar positioned between the first threaded shaft and the square neck;
attaching a visible colored section to the device on the exposed end of the device above the transmucosal collar; and
securing the temporary anchoring device and attached visible section in the mouth of a patient.

8. The method of claim 7, further comprising, after securing the device in the mouth of the patient, removing the visible colored section from the device and replacing the visible colored section with a different visible colored section.

9. The method of claim 7, wherein the temporary anchoring device is the device of claim 1.
